(19) United States
(12) Patent Application Publication
(10) Pub. No.: US 2024/0329959 A1
(43) Pub. Date: Oct. 3, 2024

(54) UPGRADING AND STANDARDIZING DEPENDANT CODE AS PART OF APPLICATION MODERNIZATION

(71) Applicant: INTERNATIONAL BUSINESS MACHINES CORPORATION, Armonk, NY (US)

(72) Inventors: Paul BARRY, Douglas (IE); Ryan Thomas CLAUSSEN, Rochester, MN (US); Vinh Tuan THAI, Markham (CA); Dana L. PRICE, Surf City, NC (US)

(21) Appl. No.: 18/127,268

(22) Filed: Mar. 28, 2023

(51) Int. Cl. G06F 8/65; G06F 8/76

(52) U.S. Cl. CPC G06F 8/65; G06F 8/76

(57) ABSTRACT

A method, system, and computer program product are configured to: identify versions of a JAR file used by applications in a system; generate a ranked list of the versions of the JAR file including a highest ranked version; determine a first subset of the applications that use the highest ranked version; determine a second subset of the applications that use a version other than the highest ranked version; for each respective one of the applications in the second subset, identify a respective upgraded version of the JAR file to use with the respective one of the applications based on comparing methods required by the respective one of the applications to sets of methods included in respective ones of the versions of the JAR file; and generate a list including the respective upgraded version of the JAR file identified for each respective one of the applications in the second subset.

### BACKGROUND

Aspects of the present invention relate generally to modernizing applications running in a computing system and, more particularly, to automatically upgrading and standardizing dependent code as part of application modernization.

During a modernization of a computing system including multiple applications, existing application code is migrated to new platforms and runtimes. This migration often requires changes in the application code to deal with the changes in the underlying operating systems, platforms (e.g., migrating from virtual machine or bare metal to containers), runtimes (e.g., migrating from one runtime version to another, or migrating to a new runtime), and programming language versions (e.g., migrating to a newer version of a programming language).

### SUMMARY

In a first aspect of the invention, there is a computer-implemented method including: identifying, by a processor set, versions of a dependent code used by applications in a system; generating, by the processor set, a ranked list of the versions of the dependent code including a highest ranked version; determining, by the processor set, a first subset of the applications that use the highest ranked version; determining, by the processor set, a second subset of the applications that use a version other than the highest ranked version; for each respective one of the applications in the second subset, identifying, by the processor set, a respective upgraded version of the dependent code to use with the respective one of the applications based on comparing methods required by the respective one of the applications to sets of methods included in respective ones of the versions of the dependent code; and generating, by the processor set, a list including the respective upgraded version of the dependent code identified for each respective one of the applications in the second subset.

In another aspect of the invention, there is a computer program product including one or more computer readable storage media having program instructions collectively stored on the one or more computer readable storage media. The program instructions are executable to: identify versions of a JAR file used by applications in a system; generate a ranked list of the versions of the JAR file including a highest ranked version; determine a first subset of the applications that use the highest ranked version; determine a second subset of the applications that use a version other than the highest ranked version; for each respective one of the applications in the second subset, identify a respective upgraded version of the JAR file to use with the respective one of the applications based on comparing methods required by the respective one of the applications to sets of methods included in respective ones of the versions of the JAR file; and generate a list including the respective upgraded version of the JAR file identified for each respective one of the applications in the second subset.

In another aspect of the invention, there is a system including a processor set, one or more computer readable storage media, and program instructions collectively stored on the one or more computer readable storage media. The program instructions are executable to: identify versions of a JAR file used by applications in a system; generate a ranked list of the versions of the JAR file including a highest ranked version; determine a first subset of the applications that use the highest ranked version; determine a second subset of the applications that use a version other than the highest ranked version; for each respective one of the applications in the second subset, identify a respective upgraded version of the JAR file to use with the respective one of the applications based on comparing methods required by the respective one of the applications to sets of methods included in respective ones of the versions of the JAR file; and generate a list including the respective upgraded version of the JAR file identified for each respective one of the applications in the second subset.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary arrangement of applications and dependent code versions in accordance with aspects of the present invention.

FIG. 4 shows a flowchart of an exemplary method in accordance with aspects of the present invention.

FIG. 5 shows an exemplary group of JAR files that are grouped by name in accordance with aspects of the present invention.

FIG. 6 shows an exemplary symbol table for a group of JAR files in accordance with aspects of the present invention.

FIG. 7 shows a flowchart of an exemplary method in accordance with aspects of the present invention.

### DETAILED DESCRIPTION

Aspects of the present invention relate generally to modernizing applications running in a computing system and, more particularly, to automatically upgrading and standardizing dependent code as part of application modernization. Modernizing a computing system typically involves migrating the computing system from a current environment to a new environment that may contain new platforms and new runtimes. To support simplicity of operations, a goal of migration is typically to modernize an entire application estate so that all applications run on the same infrastructure with the same access mechanisms and operational support structures.

It is typical for applications to have a set of dependent code (e.g., JAR files) and, as the application estate grows, different applications use different versions of the dependent code (e.g., different versions of a JAR file). A JAR (Java ARchive) file is a type of dependent code that is a package file format used to aggregate Java class files and associated metadata and resources (e.g., text, images, etc.) into one file for distribution. Such JAR files may need to be modified to support the new target environments in the same manner as application specific code. With multiple different versions of a JAR file being used by different applications in the application estate, a migration can involve a significant amount of effort because the migration requires modifying all the different versions of the JAR file to operate correctly in the target environment.

Different versions of a JAR file may be created for various reasons. For example, when creating a new application, a developer will often start with a current version of a JAR file that is used by an existing application and create a new version of the JAR file by adding one or more features (e.g., methods) to the current version of the JAR file. In this example, the result is the computing system including a first application that uses a first version of the JAR file and a second application that uses a second version of the JAR file. This can be repeated multiple times until there are a many different versions of a JAR file being used by different applications in the computing system. For example, it is not uncommon to have ten or more different versions of a JAR file being used by different applications in a computing system. This causes an issue when migrating the computing system to a new environment. The issue in this case is that it requires effort to ensure that each different version of the JAR file operates as intended in the new environment. This effort may be referred to as modernization effort and may be measured in terms of days of effort, which are days spent by a developer working to ensure that each different version of the JAR file works as intended in the new environment. It is not uncommon for the modernization effort of a single version of a JAR file to be as high as ten (10) days. As such, there can be a very high cost in terms of modernization effort when modernizing a computing system that includes many different versions of a JAR file being used by different applications.

Implementations of the invention address this problem using JAR file naming combined with static code scans to identify candidate JAR files that can potentially be upgraded as part of modernization. In embodiments, a method, system, and computer program product are configured to: identify all common dependent code (e.g., JAR files) across an application estate and determine a modernization cost of each; group the JAR files together by name; generate a static code graph for each application; generate a static code graph for each JAR file; and compare the latest version of the JAR file to each application that uses any version of this JAR file to characterize the suitability of the application to use the latest version. During the comparing, if the JAR file the application uses is not characterized as being suitable for automatic upgrade, then the comparing is repeated for the next version of the JAR file. In embodiments, the candidate JAR files belonging to each application are categorized in one of three ways: suitable for automatic upgrade; automatic upgrade but suggest review; and unsuitable for automatic upgrade.

Embodiments reduce the number of different versions of a JAR file used by multiple applications in a computing system by upgrading ones of the applications from lower ranked versions of the JAR file to higher ranked versions of the JAR file, essentially consolidating the applications into fewer versions of the JAR file. Reducing the number of different versions of a JAR file provides a reduction in the amount of effort required to modernize the computing system, since there are less versions of the JAR file to analyze as part of the modernization. In this manner, implementations provide an improvement in the technical field of migrating a computing system to a new environment.

Embodiments can be used to reduce the number of JAR files considered for upgrade, when modernizing, to only those JAR files that will have issues associated with them for this modernization. This approach optimizes the return in investment for the modernization and ensures only work required for the modernization is undertaken. Embodiments do not require manual input to reduce the number of different versions of a JAR file, and do not simply take the latest version of a JAR file to use for all the applications that use versions of the JAR file. Instead, embodiments scan across the whole application estate and identify the latest version of the JAR file already being used. This is advantageous in terms of an estate wide modernization as it enables the smallest possible change to support the modernization, without the need to clear new versions of the JAR file to meet license, security, and compliance requirements.

Embodiments also provide the ability to identify an optimal version of the JAR file to which to move applications to, even when all the signatures of methods used by an application are a subset of those in an upgrade candidate. Embodiments may rank the versions of a JAR file based on modernization effort, and may migrate an application to an intermediate version of the JAR file that is not the latest version of the JAR file even when the latest version will support the application.

As will be understood from the present disclosure, embodiments provide for a method comprising: scanning software applications and identify one or more JAR files that is dependent on the software applications; applying one or more rules for a target environment to determine which JAR files from the one or more jar require modification to work in the target environment; grouping the one or more JAR files together based on a grouping rule; performing a first static code scan over each of the software application, wherein the static code scan is based on the one or more JAR files; performing a second static code scan over a plurality of version of the one or more JAR files to obtain a list of methods and signatures based on a jar symbol table; for each of the plurality of version of the one or more JAR files, comparing, iteratively, the first static code scan against the jar symbol table and determining a flag status of the software application by using comparison rule, wherein the comparison rule further comprises: if the scanned software application is not a subset (or equal to) the jar symbol table then flag the software application as unsuitable for automatic migration, and if the scanned software application is a subset (or equal to) the jar symbol table then either flag the software application for possible review or flag the software application for automatic migration; and outputting a list of automatic upgrades based on the flag status of the software application.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as upgrading code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

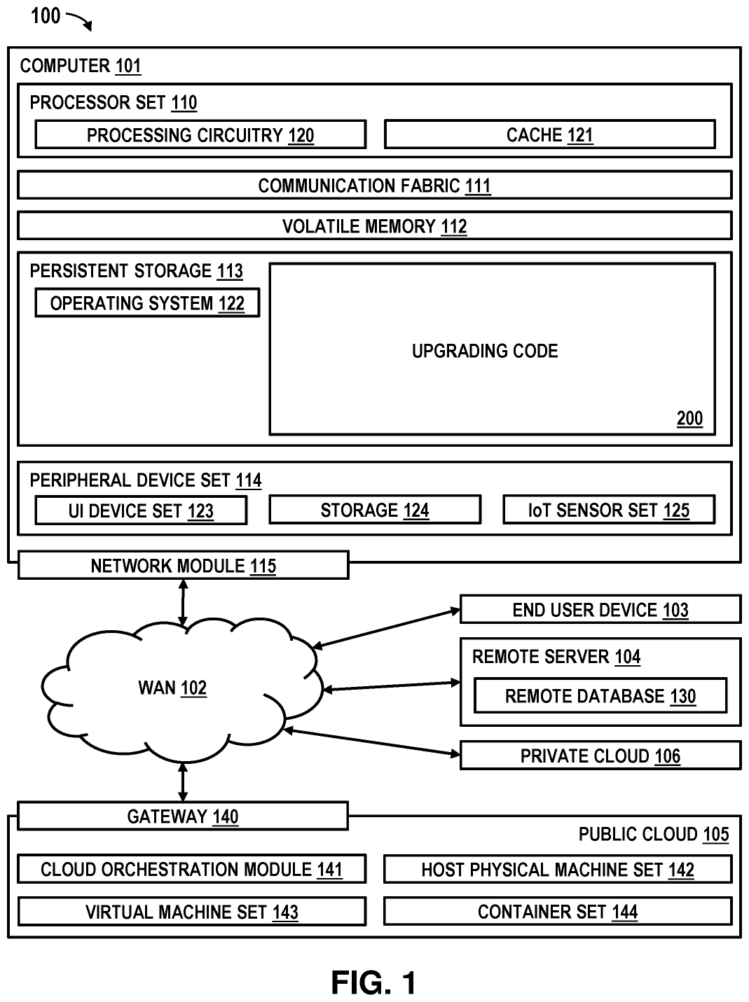

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

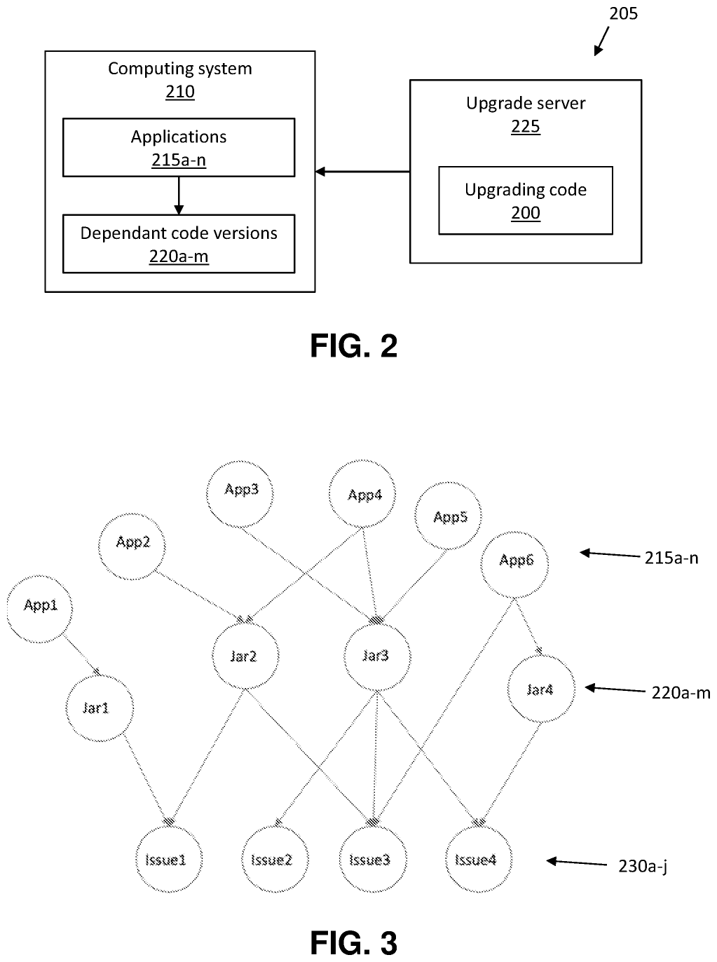

FIG. 2 shows a block diagram of an exemplary environment 205 in accordance with aspects of the invention. In embodiments, the environment 205 includes a computing system 210 that includes plural applications 215a-n and plural dependent code versions 220a-m, where ‘n’ and ‘m’ are integers. In one example, ‘n’ is greater than ‘m’. In embodiments, each of the applications 215a-n comprises an application program (e.g., a computer program) designed to carry out a specific task other than one relating to the operation of a computer itself. In embodiments, the dependent code versions 220a-m comprise plural different versions of a JAR file used by the applications 215a-n. Each of the applications 215a-n is associated with a respective classpath that defines one of the dependent code versions 220a-m used by the application.

In accordance with aspects of the invention, the environment 205 includes an upgrade server 225 that runs the upgrading code of block 200 of FIG. 1. The upgrade server 225 may comprise one or more instances of computer 101 of FIG. 1. The upgrade server 225 may alternatively comprise one or more virtual machines or one or more containers running on one or more instances of computer 101 of FIG. 1. In an exemplary implementation, the computing system 210 is comprised in the private cloud 106 of FIG. 1 or comprises one or more instances of a remote server 104 of FIG. 1, the applications 215a-n are run by the computing system 210, and the upgrade server 225 communicates with the computing system 210 via one or more networks such as the WAN 102 of FIG. 1.

The upgrading code of block 200 may comprise routines, programs, objects, components, logic, data structures, and so on that perform particular tasks or implement particular data types to carry out the functions and/or methodologies of embodiments of the invention as described herein. The upgrading code of block 200 is executable by the processing circuitry 120 of FIG. 1 to perform the inventive methods as described herein. The upgrade server 225 may include additional or fewer code modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

FIG. 3 shows an exemplary arrangement of the applications 215a-n and dependent code versions 220a-m of FIG. 2. In this example, the applications 215a-n comprise App1, App2, App3, App4, App5, App6, which are different applications in the computing system 210 of FIG. 2. In this example, the dependent code versions 220a-m comprise Jar1, Jar2, Jar3, Jar4, which are different versions of a JAR file. In this example, App1 uses Jar1, App2 uses Jar2, App3 uses Jar3, App4 uses Jar2 and Jar3, App5 uses Jar3, and App6 uses Jar4. Also shown in FIG. 3 are issues 230a-j comprising Issue1, Issue2, Issue3, Issue4 that represent specific issues identified for particular ones of the JAR files when migrating the computing system to a new environment. In this example, the applications 215a-n are on-premise applications, the new environment is a cloud environment, and the issues 230a-j are migration issues involved in migrating the dependent code versions 220a-m to the cloud environment. In embodiments, the upgrading code of block 200 includes or calls a modernization tool that identifies the issues, such as issues 230a-j in this example. In embodiments, the modernization tool also estimates an amount of effort (e.g., modernization effort in terms of days) required for resolving each of the identified issues, such as issues 230a-j in this example.

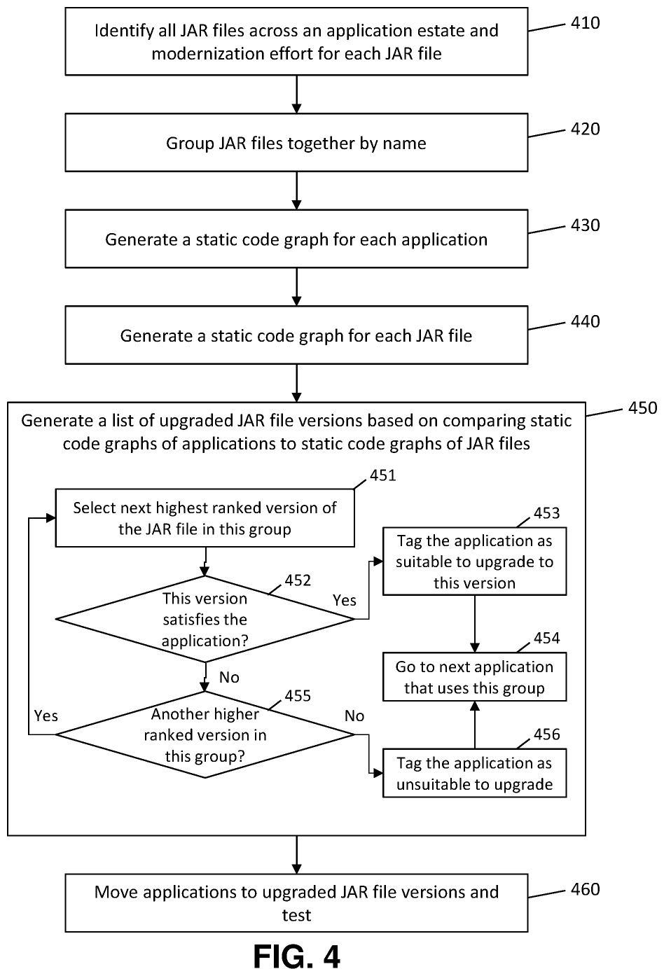

FIG. 4 shows a flowchart of an exemplary method in accordance with aspects of the present invention. Steps of the method may be carried out in the environment of FIG. 2 and are described with reference to elements depicted in FIG. 2.

At step 410, the system identifies all JAR files across an application estate and a modernization effort for each JAR file. In embodiments, the JAR files comprise different dependent code files, each of which may have multiple different versions (e.g., such as dependent code versions 220a-m). In embodiments, the application estate comprises the applications 215a-n. In embodiments, the upgrading code of block 200 performs step 410 by scanning all the applications 215a-n and identifying the list of JAR files that each application uses. This may be performed, for example, by analyzing the classpath of each application.

In embodiments, the upgrading code of block 200 includes or calls a modernization tool that determines a modernization effort for each of the identified JAR files. In embodiments, the modernization tool applies rules for the target environment to determine which of the identified JAR files require modification to work in this new environment. For example, the rules may be configured to determine issues with each of the identified JAR files based on the target environment, and to determine a modernization effort (e.g., in terms of days of effort) for each of the identified JAR files based on the issues.

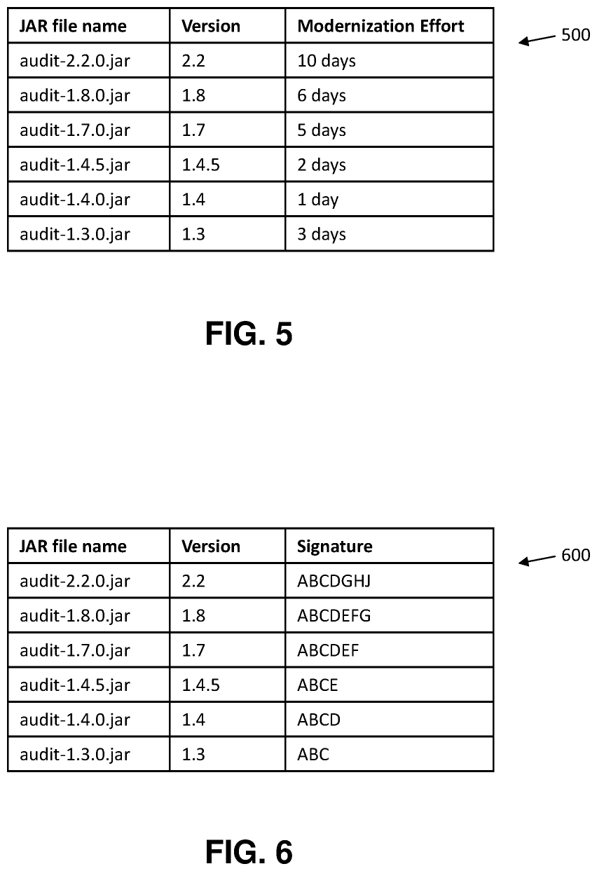

At step 420, the system groups the JAR files together by name. The JAR files identified at step 410 may comprise different dependent code files, each of which may have multiple different versions. As an illustrative example, the identified JAR files may include abc-1.0.jar, abc-1.1.jar, abc-2.1.jar, xyz-1.0.jar, xyz-1.5.jar, and xyz-1.6.jar. At step 420, the upgrading code of block 200 groups these JAR file together by name such that the versions of abc-#.#.jar are grouped together, the versions of xyz-#.#.jar are grouped together, etc. FIG. 5 shows another example of a group 500 of JAR files that are grouped by name at step 420. In the example shown in FIG. 5, the JAR file named ‘audit-#.#.#.jar’ has seven different versions that are grouped together. In this example, the group 500 includes the modernization effort for each version that is determined at step 410. As shown in FIG. 5, the group 500 may have gaps between version numbers. This can result from intermediate versions of the JAR file not being used by any of the applications. For example, audit-1.6.0.jar (not shown) may exist in the system but is not called by any of the applications. As a result, audit-1.6.0.jar is not included in the group 500.

At step 430, the system generates a static code graph for each of the applications identified at step 410. In embodiments, the upgrading code of block 200 runs a static code scan over each of the identified applications that uses one of the identified JAR files. In embodiments, the static code scan identifies, for a particular application, methods (e.g., signatures) in the JAR file that are called by the application. In embodiments, the static code scan performs this identification by reading and analyzing the binaries in the application to determine signatures of each call to the JAR file made by the application.

At step 440, the system generates a static code graph for each JAR file identified at step 410. In embodiments, the upgrading code of block 200 runs a static code scan over each of the JAR files. In embodiments, the static code scan analyzes the contents of the JAR file to identify all the methods that are provided by (e.g., included in) the JAR file. In embodiments, the upgrading code of block 200 creates a symbol table for a group of JAR files, where the symbol table lists the methods provided by each different version of the JAR file in the group. FIG. 6 shows an example symbol table 600 for the group of JAR files named ‘audit-#.#.#.jar’ from FIG. 5. The ‘Signature’ column of the table 600 lists the methods provided by each version. For example, version 1.3 provides methods A, B, and C, while version 1.4 provides methods A, B, C, and D, and so on as shown in the figure, where different letters (e.g., A, B, C, etc.) represent different methods included in the JAR file.

At step 450, the system generates a list of upgraded JAR file versions based on comparing static code graphs of applications to static code graphs of JAR files. In embodiments, for each application that uses one of the JAR files in the group, the upgrading code of block 200 compares the methods called by the application (from step 430) to the methods included in the different versions of the JAR files in the group (from step 440).

In embodiments, step 450 comprises the upgrading code of block 200 starting a subprocess at step 451 for each application that uses a particular group of JAR files. The subprocess is described using exemplary group 500 and table 600 for illustration, although implementations are not limited to using group 500 and table 600 and other groups with other symbol tables may be used.

At step 451, for the current application being considered, the upgrading code of block 200 selects the next highest ranked version of the JAR file in the group (e.g., group 500). For a first pass through the subprocess, the next highest ranked version is the highest ranked version of the JAR file in the group.

In one example, the upgrading code of block 200 ranks the versions of the JAR file in a group according to version number, with the highest version number being the highest ranked and the lowest version number being the lowest ranked. In this example, and considering the group 500 of FIG. 5, audit-2.2.0.jar is the highest ranked version, audit-1.8.0.jar is the second highest ranked version, and so on, to audit-1.3.0.jar which is the lowest ranked version.

In another example, the upgrading code of block 200 ranks the versions of the JAR file in a group according to modernization effort, with the lowest modernization effort being the highest ranked and the highest modernization effort being the lowest ranked. In this example, and considering the group 500 of FIG. 5, audit-1.4.0.jar is the highest ranked version, audit-1.4.5.jar is the second highest ranked version, and so on, to audit-2.2.0.jar which is the lowest ranked version.

At step 452, the upgrading code of block 200 determines whether the selected version (from step 451) satisfies the application. In embodiments, the upgrading code of block 200 makes this determination by comparing the methods called by the application (determined at step 430) to the methods included in this version of the JAR file (determined at step 440). If this version of the JAR file includes the set of methods called by the application, then this version of the JAR file is deemed to satisfy the application, and at step 453 the application is tagged as suitable for upgrade to this version of the JAR file. If this version of the JAR file does not include the set of methods called by the application, then this version of the JAR file is deemed to not satisfy the application, and at the subprocess proceeds to step 455. At step 455, the code determines whether there is another higher ranked version of the JAR file in the group. Step 455 may comprise the upgrading code of block 200 comparing the ranking of version of the JAR file currently used by the application under consideration to the other versions of the JAR file in the group. If there is another higher ranked version of the JAR file in the group, then the subprocess returns to step 451 where the upgrading code of block 200 selects the next highest ranked version for comparison to this application. If there is not another higher ranked version of the JAR file in the group, then the subprocess proceeds to step 456 where the upgrading code of block 200 deems this application unsuitable for upgrading the version of the JAR file it uses. After step 453 or step 456, the upgrading code of block 200 goes to the next application that uses this group and starts the subprocess at step 451 for this next application. In this manner, the upgrading code of block 200 considers each application individually and determines whether the application can be upgraded to a higher ranked version of the JAR file (e.g., ranked higher than the version currently used by the application), wherein the determination is based on comparing the methods called by the application and the methods included in versions of the JAR file.

In embodiments, in response to determining that an application under consideration is suitable for upgrade at step 453, the upgrading code of block 200 tags the application as either (a) suitable for upgrade without review or (b) suitable for upgrade with review. In embodiments, the application is suitable for upgrade without review when two conditions are both satisfied: (1) the version of the JAR file being upgraded to is not a major version higher than the version of the JAR file currently used by the application, and (2) the version of the JAR file being upgraded to differs from the version of the JAR file currently used by the application by less than the predefined amount.

In embodiments regarding the first condition, a major version higher is a version in which the first digit of the JAR file being upgraded to differs from the first digit of the version of the JAR file currently used by the application. In a first example using the group 500 for illustration, audit-1.4.0.jar is not a major version higher than audit-1.3.0.jar because both versions have the same first digit in their version number, i.e., ‘1’. In this first example, upgrading an application from audit-1.3.0.jar to audit-1.4.0.jar satisfies the first condition because the upgrade is not to a major version higher. In a second example using the group 500 for illustration, audit-2.2.0.jar is a major version higher than audit-1.3.0.jar because the versions have a different first digit in their version number, i.e., ‘2’ versus ‘1’. In this second example, upgrading an application from audit-1.3.0.jar to audit-2.2.0.jar does not satisfy the first condition because the upgrade is to a major version higher.

In embodiments regarding the second condition, a version of the JAR file being upgraded to differs by less than the predefined amount when the version being upgraded to is less than X % different from the version currently used by the application. The number ‘X’ may be a user-defined parameter. In an exemplary implementation, X=20 such that X %=20%. In embodiments, the difference is determined based on the number of methods included by each version, e.g., as determined at step 440. In an example using the group 500 for illustration, audit-1.8.0.jar is more than 20% different from audit-1.3.0.jar based on the number of methods supported by each version (e.g., 3 versus 7). As such, upgrading from audit-1.3.0.jar to audit-1.8.0.jar would not satisfy the second condition. In another example using the group 500 for illustration, audit-1.8.0.jar is less than 20% different from audit-1.7.0.jar based on the number of methods supported by each version (e.g., 6 versus 7). As such, upgrading from audit-1.7.0.jar to audit-1.8.0.jar would satisfy the second condition.

In embodiments, when both conditions are satisfied at step 453, the upgrading code of block 200 tags the application as suitable for upgrade without review (i.e., upgrade to the version of the JAR file selected at step 451 of the current iteration of the subprocess for this particular application). In embodiments, upgrade without review means that the upgrading code of block 200 does not generate an alert to the user regarding the suitableness of upgrading this application to the selected version.

In embodiments, when one or both conditions are not satisfied at step 453, the upgrading code of block 200 tags the application as suitable for upgrade with review (i.e., upgrade to the version of the JAR file selected at step 451 of the current iteration of the subprocess for this particular application). In embodiments, upgrade with review means that the upgrading code of block 200 generates an alert to the user regarding the suitableness of upgrading this application to the selected version. In embodiments, the alert notifies the user that the application is suitable for upgrade to a different version of the JAR file but that the user should monitor the performance of the application after upgrade. This is because matching the method signatures (e.g., as at step 452) guarantees that the methods needed by the application can be called in the upgraded version of the JAR file, but not that the outputs will be the same as the current version of the JAR file. Review may include a suggestion to examine the release notes for the upgraded version to identify if significant changes are called out. Review can be skipped if extensive app testing is undergone since the testing will uncover any issues with outputs.

At step 460, the system moves the applications to the upgraded JAR file versions and tests the application with their upgraded versions. In embodiments, for a group of versions (such as group 500), for each application that is tagged as suitable for upgrade within the group (e.g., as determined at step 453), the upgrading code of block 200 upgrades each application to its upgraded version of the JAR file in the group. In one example, upgrading the application comprises the upgrading code of block 200 changing the classpath of the application to point to the upgraded version of the JAR file instead of the version of the JAR file currently used by the application. In another example, upgrading the application comprises the upgrading code of block 200 deleting the current version of the JAR file from the location defined in the classpath of the application and saving the upgraded version of the JAR file in this location. In both examples, when the application loads files using its classpath, it loads the upgraded version of the JAR file rather than the version of the JAR file that was previously used by this application.

In this manner, applications that use lower ranked versions of the JAR file are upgraded to higher ranked versions of the JAR file in the same group. In this manner, after the upgrading, one or more of the versions of the JAR file in the group may be left without any application using them. In an example using the group 500 for illustration, before upgrading, all of the versions in the group are used by at least one application. In this example, after upgrading, one or more of the versions (e.g., audit-1.3.0.jar and audit-1.4.0.jar) are no longer used by an application because the applications that did use these versions have been upgraded to other versions in the group. As a result, when the computing system is migrated to the new environment, the unused versions of the JAR file (e.g., audit-1.3.0.jar and audit-1.4.0.jar) are not migrated since they are no longer in use. Eliminating the migration of these versions advantageously reduces the modernization effort of the computing system as a whole since it eliminates a portion of the modernization effort associated with these versions. In this example, the modernization effort of the computing system as a whole is reduced by 4 days (e.g., 3 days for audit-1.3.0.jar plus 1 day for audit-1.4.0.jar).

In embodiments, step 460 includes testing an application after upgrading the application to a new version of the JAR file. In embodiments, the testing comprises testing the application with the upgraded version of the JAR file to confirm that performance and outcomes are as expected.

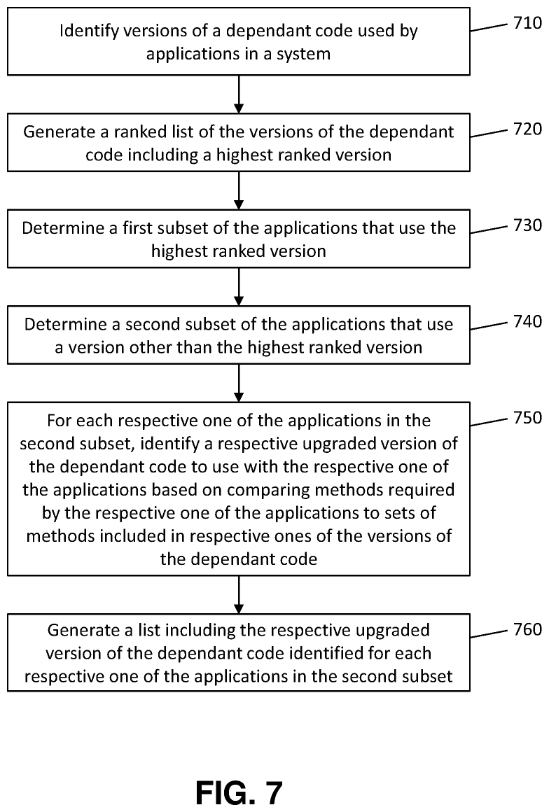

FIG. 7 shows a flowchart of an exemplary method in accordance with aspects of the present invention. Steps of the method may be carried out in the environment of FIG. 2 and are described with reference to elements depicted in FIG. 2.

At step 710, the system identifies versions of a JAR file used by applications in a system. In embodiments, the upgrading code of block 200 identifies all JAR files in the computing system (e.g., as at step 410) and groups the JAR files together by name (e.g., as at step 420).

At step 720, the system generates a ranked list of the versions of the JAR file including a highest ranked version. In embodiments, the upgrading code of block 200 ranks the versions of the JAR file in the group according to version number or modernization effort, e.g., as described with respect to FIGS. 4-6.

At step 730, the system determines a first subset of the applications that use the highest ranked version. In embodiments, the upgrading code of block 200 determines a first subset of the group (e.g., of the group 500) that already use the highest ranked version of the JAR file. In embodiments, the system does not upgrade these applications to another version of the JAR file since these applications already use the highest ranked version of the JAR file.

At step 740, the system determine a second subset of the applications that use a version other than the highest ranked version. At step 750, for each respective one of the applications in the second subset, the system identifies a respective upgraded version of the JAR file to use with the respective one of the applications. In embodiments, the upgrading code of block 200 identifies the respective upgraded version based on comparing methods required by the respective one of the applications to sets of methods included in respective ones of the versions of the JAR file, e.g., as described at steps 430, 440, and 450.

At step 760, the system generates a list including the respective upgraded version of the JAR file identified for each respective one of the applications in the second subset. Step 760 may be performed in a manner similar to step 460.

The method may comprise generating an alert for a respective one of the applications in the second subset based on one of: determining that the respective upgraded version of the JAR file to use with the respective one of the applications is a major version higher than a one of the versions of the JAR file currently used by the respective one of the applications; and determining that the respective upgraded version of the JAR file to use with the respective one of the applications differs from a one of the versions of the JAR file currently used by the respective one of the applications by more than a predefined amount.

In embodiments of the method, the respective upgraded version of the JAR file to use with the respective one of the applications is ranked higher in the ranked list than a one of the versions of the JAR file currently used by the respective one of the applications.

The method may comprise upgrading each respective one of the applications in the second subset to its respective upgraded version of the JAR file. In embodiments, at least one of the versions of the JAR file is no longer used by any of the applications after the upgrading.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying, by a processor set, versions of a dependent code used by applications in a system;
generating, by the processor set, a ranked list of the versions of the dependent code including a highest ranked version;
determining, by the processor set, a first subset of the applications that use the highest ranked version;
determining, by the processor set, a second subset of the applications that use a version other than the highest ranked version;
for each respective one of the applications in the second subset, identifying, by the processor set, a respective upgraded version of the dependent code to use with the respective one of the applications based on comparing methods required by the respective one of the applications to sets of methods included in respective ones of the versions of the dependent code; and
generating, by the processor set, a list including the respective upgraded version of the dependent code identified for each respective one of the applications in the second subset.

2. The method of claim 1, wherein the dependent code comprises a JAR file, and the versions of the dependent code comprise versions of the JAR file.

3. The method of claim 2, wherein the identifying the versions of the dependent code comprises:
identifying multiple JAR files in the system; and
grouping subsets of the multiple JAR files according to name, wherein the versions of the dependent code comprise one of the subsets of the multiple JAR files.

4. The method of claim 1, further comprising generating an alert for a respective one of the applications in the second subset based on one of:
determining that the respective upgraded version of the dependent code to use with the respective one of the applications is a major version higher than a one of the versions of the dependent code currently used by the respective one of the applications; and
determining that the respective upgraded version of the dependent code to use with the respective one of the applications differs from a one of the versions of the dependent code currently used by the respective one of the applications by more than a predefined amount.

5. The method of claim 1, wherein the respective upgraded version of the dependent code to use with the respective one of the applications is ranked higher in the ranked list than a one of the versions of the dependent code currently used by the respective one of the applications.

6. The method of claim 1, wherein the ranked list is generated based on version numbers of the versions of the dependent code, with the highest ranked version having a highest version number and a lowest ranked version having a lowest version number.

7. The method of claim 1, wherein the ranked list is generated based on modernization effort of the versions of the dependent code, with the highest ranked version having a lowest modernization effort and a lowest ranked version having a highest modernization effort.

8. The method of claim 1, further comprising, for each respective one of the applications, performing a static code scan that identifies the methods used by the respective one of the applications.

9. The method of claim 1, further comprising, for each respective one of the versions of the dependent code, performing a static code scan that identifies the methods included in the respective one of the versions.

10. The method of claim 1, further comprising upgrading each respective one of the applications in the second subset to its respective upgraded version of the dependent code.

11. A computer program product comprising one or more computer readable storage media having program instructions collectively stored on the one or more computer readable storage media, the program instructions executable to:
identify versions of a JAR file used by applications in a system;
generate a ranked list of the versions of the JAR file including a highest ranked version;
determine a first subset of the applications that use the highest ranked version;
determine a second subset of the applications that use a version other than the highest ranked version;
for each respective one of the applications in the second subset, identify a respective upgraded version of the JAR file to use with the respective one of the applications based on comparing methods required by the respective one of the applications to sets of methods included in respective ones of the versions of the JAR file; and
generate a list including the respective upgraded version of the JAR file identified for each respective one of the applications in the second subset.

12. The computer program product of claim 11, wherein the identifying the versions of the dependent code comprises:
identifying multiple JAR files in the system; and
grouping subsets of the multiple JAR files according to name, wherein the versions of the dependent code comprise one of the subsets of the multiple JAR files.

13. The computer program product of claim 11, wherein the program instructions executable to generate an alert for a respective one of the applications in the second subset based on one of:
determining that the respective upgraded version of the JAR file to use with the respective one of the applications is a major version higher than a one of the versions of the JAR file currently used by the respective one of the applications; and
determining that the respective upgraded version of the JAR file to use with the respective one of the applications differs from a one of the versions of the JAR file currently used by the respective one of the applications by more than a predefined amount.

14. The computer program product of claim 11, wherein the respective upgraded version of the JAR file to use with the respective one of the applications is ranked higher in the ranked list than a one of the versions of the JAR file currently used by the respective one of the applications.

15. The computer program product of claim 11, wherein the program instructions executable to upgrade each respective one of the applications in the second subset to its respective upgraded version of the JAR file, and
wherein at least one of the versions of the JAR file is no longer used by any of the applications after the upgrading.

16. A system comprising:
a processor set, one or more computer readable storage media, and program instructions collectively stored on the one or more computer readable storage media, the program instructions executable to:
identify versions of a JAR file used by applications in a system;
generate a ranked list of the versions of the JAR file including a highest ranked version;
determine a first subset of the applications that use the highest ranked version;
determine a second subset of the applications that use a version other than the highest ranked version;
for each respective one of the applications in the second subset, identify a respective upgraded version of the JAR file to use with the respective one of the applications based on comparing methods required by the respective one of the applications to sets of methods included in respective ones of the versions of the JAR file; and
generate a list including the respective upgraded version of the JAR file identified for each respective one of the applications in the second subset.

17. The system of claim 16, wherein the identifying the versions of the dependent code comprises:
identifying multiple JAR files in the system; and
grouping subsets of the multiple JAR files according to name, wherein the versions of the dependent code comprise one of the subsets of the multiple JAR files.

18. The system of claim 16, wherein the program instructions executable to generate an alert for a respective one of the applications in the second subset based on one of:
determining that the respective upgraded version of the JAR file to use with the respective one of the applications is a major version higher than a one of the versions of the JAR file currently used by the respective one of the applications; and
determining that the respective upgraded version of the JAR file to use with the respective one of the applications differs from a one of the versions of the JAR file currently used by the respective one of the applications by more than a predefined amount.

19. The system of claim 16, wherein the respective upgraded version of the JAR file to use with the respective one of the applications is ranked higher in the ranked list than a one of the versions of the JAR file currently used by the respective one of the applications.

20. The system of claim 16, wherein the program instructions executable to upgrade each respective one of the applications in the second subset to its respective upgraded version of the JAR file, and
wherein at least one of the versions of the JAR file is no longer used by any of the applications after the upgrading.
